(19) United States
(12) Patent Application Publication
(10) Pub. No.: US 2003/0033746 A1
(43) Pub. Date: Feb. 20, 2003

(54) Live well cooling and aeration system

(76) Inventors: Mark A. Johnson, Browerville, MN (US); Stephen Klarich, Miltona, MN (US); Clay Hager, Miltona, MN (US)

Correspondence Address: Michael S. Neustel, Suite No. 4, 2534 South University Drive, Fargo, ND, 58103, US

(21) Appl. No.: 09/930,363

(22) Filed: Aug. 16, 2001

(51) Int. Cl. A01K 97/00

(52) U.S. Cl. 43/55

(57) ABSTRACT

A live well cooling and aeration system for preventing fish within a live well from dieing because of undesirable temperature and aeration conditions. The live well cooling and aeration system includes a cold plate positionable within an interior portion of a live well of a boat, a compressor in fluid communication with the cold plate, a condensing coil in fluid communication with the compressor, and an aeration unit in fluid communication with the interior portion of the live well. A thermostat within the live well determines when the compressor circulates coolant through the cold plate when the temperature of the water within the live well exceeds a maximum level. When the temperature of the water within the live well is lowered to a minimum level, the thermostat terminates operation of the compressor. The aeration unit draws water from within the live well, aerates the water and then returns the aerated water back into the live well.

### BACKGROUND OF THE INVENTION

1. Field of the Invention

The present invention relates generally to live wells utilized upon boats and more specifically it relates to a live well cooling and aeration system for preventing fish within a live well from dieing because of undesirable temperature and aeration conditions.

2. Description of the Prior Art

Live wells within boats have been in use for years. Typically, a live well is comprised of a reservoir structure capable of receiving a volume of water and fish within. The live well may be insulated to assist in maintaining a desirable water temperature for the fish contained within. In addition, a cover may be attachable to the upper opening of the live well for further assisting in maintaining a desirable temperature within the live well. More recently, some boats utilize a water exchange system where fresh water from the body of water surrounding the boat is brought into the live well with the heated water within the live well dispensed back into the body of water.

The main problem with conventional live wells is that they are not suitable for maintaining the life of fish within for extended periods of time such as but not limited to during fishing tournament usage. A further problem with conventional live wells is that they are not suitable maintaining a proper and desirable aeration of the water within the live well to further maintain the life of the fish within.

Examples of patented devices which may be illustrative of such prior art include U.S. Pat. No. 6,044,901 to Basala; U.S. Pat. No. 5,010,681 to Cox; U.S. Pat. No. 5,172,511 to Smith; U.S. Pat. No. 5,996,977 to Burgess; U.S. Pat. No. 4,712,327 to Ross;

U.S. Pat. No. 4,821,445 to Bass; U.S. Pat. No. 4,945,672 to Raia; U.S. Pat. No. 4,708,084 to Campau.

While these devices may be suitable for the particular purpose to which they address, they are not as suitable for preventing fish within a live well from dieing because of undesirable temperature and aeration conditions. Conventional live wells do not provide for adequate temperature and aeration maintenance for maintaining the lives of fish contained within for extended periods of time.

In these respects, the live well cooling and aeration system according to the present invention substantially departs from the conventional concepts and designs of the prior art, and in so doing provides an apparatus primarily developed for the purpose of preventing fish within a live well from dieing because of undesirable temperature and aeration conditions.

### SUMMARY OF THE INVENTION

In view of the foregoing disadvantages inherent in the known types of live wells now present in the prior art, the present invention provides a new live well cooling and aeration system construction wherein the same can be utilized for preventing fish within a live well from dieing because of undesirable temperature and aeration conditions.

The general purpose of the present invention, which will be described subsequently in greater detail, is to provide a new live well cooling and aeration system that has many of the advantages of the live wells mentioned heretofore and many novel features that result in a new live well cooling and aeration system which is not anticipated, rendered obvious, suggested, or even implied by any of the prior art live wells, either alone or in any combination thereof.

To attain this, the present invention generally comprises a cold plate positionable within an interior portion of a live well of a boat, a compressor in fluid communication with the cold plate, a condensing coil in fluid communication with the compressor, and an aeration unit in fluid communication with the interior portion of the live well. A thermostat within the live well determines when the compressor circulates coolant through the cold plate when the temperature of the water within the live well exceeds a maximum level. When the temperature of the water within the live well is lowered to a minimum level, the thermostat terminates operation of the compressor. The aeration unit draws water from within the live well, aerates the water and then returns the aerated water back into the live well.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a live well cooling and aeration system that will overcome the shortcomings of the prior art devices.

A second object is to provide a live well cooling and aeration system for preventing fish within a live well from dieing because of undesirable temperature and aeration conditions.

Another object is to provide a live well cooling and aeration system that may be utilized within existing live wells or permanently installed during manufacturing of a boat.

An additional object is to provide a live well cooling and aeration system that may be utilized within various designs and structures of live wells.

A further object is to provide a live well cooling and aeration system that preserves natural resources particularly in catch and release fishing tournaments.

Another object is to provide a live well cooling and aeration system that is compact in size and unobtrusive within a boat.

A further object is to provide a live well cooling and aeration system that maintains a desirable water temperature within the live well.

Another object is to provide a live well cooling and aeration system that maintains a desirable water aeration within the live well.

A further object is to provide a live well cooling and aeration system that may operate within one or more lives wells simultaneously.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention positioned within a boat with multiple live wells.

FIG. 2 is an upper perspective view of the present invention with the cold plate positioned within a live well and with the condensing coil positioned within a housing surrounding the compressor as one compact unit.

FIG. 3 is a side view of the present invention installed within a boat and a live well.

FIG. 4 is a side view of an alternative embodiment present invention illustrating the usage of an inlet pipe and pump for drawing water about the condensing coil.

FIG. 5 is a side view of the present invention illustrating the condensing coil positioned away from the compressor.

### DESCRIPTION OF THE PREFERRED EMBODIMENT

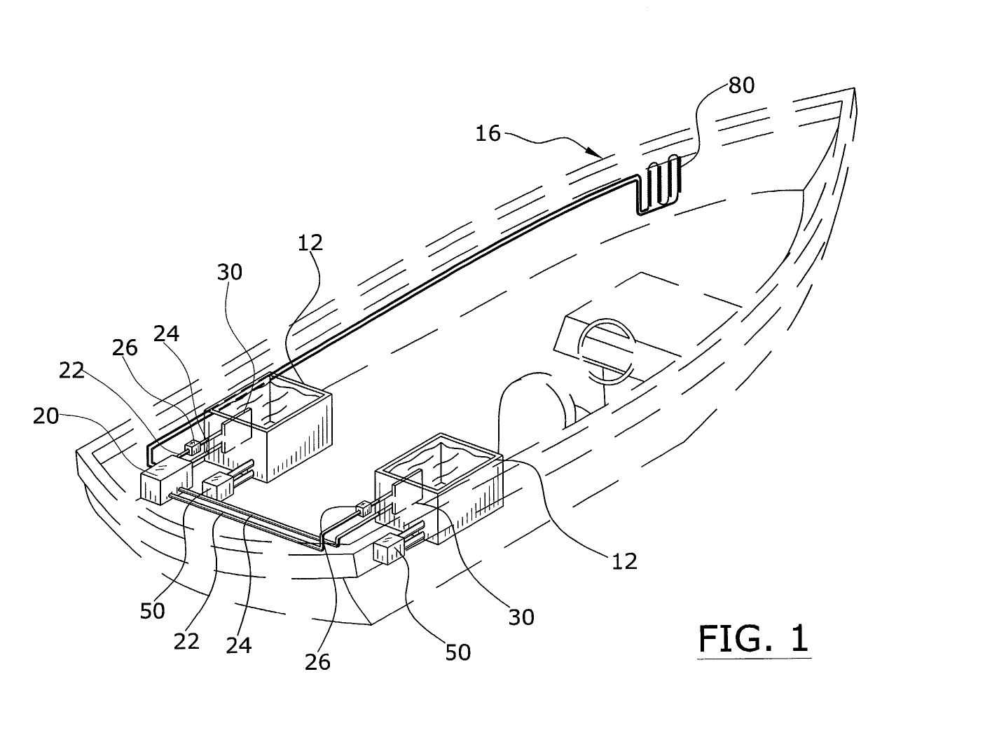

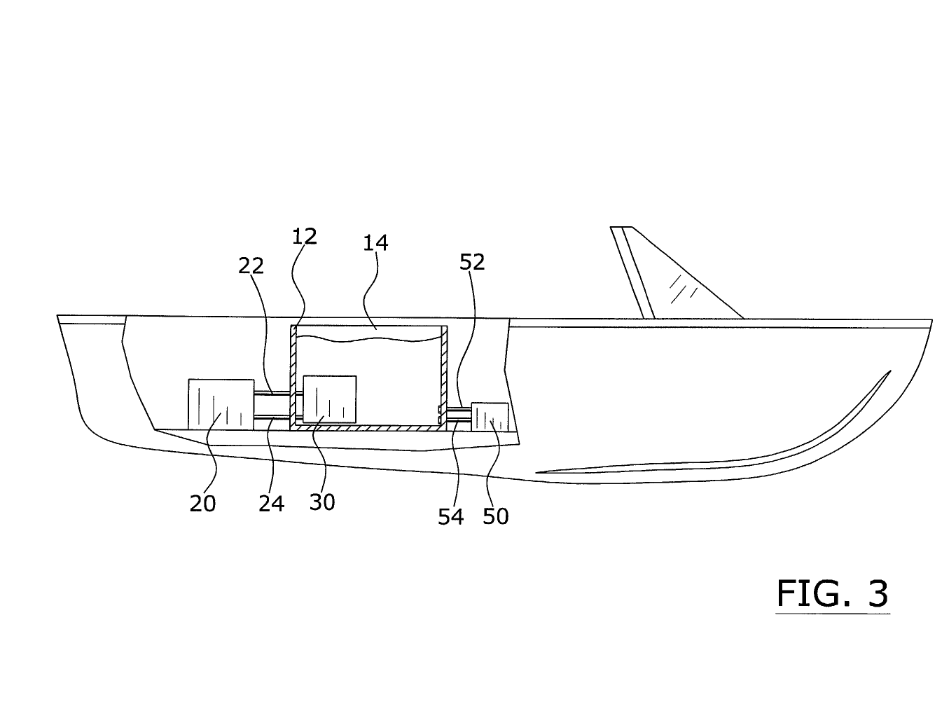

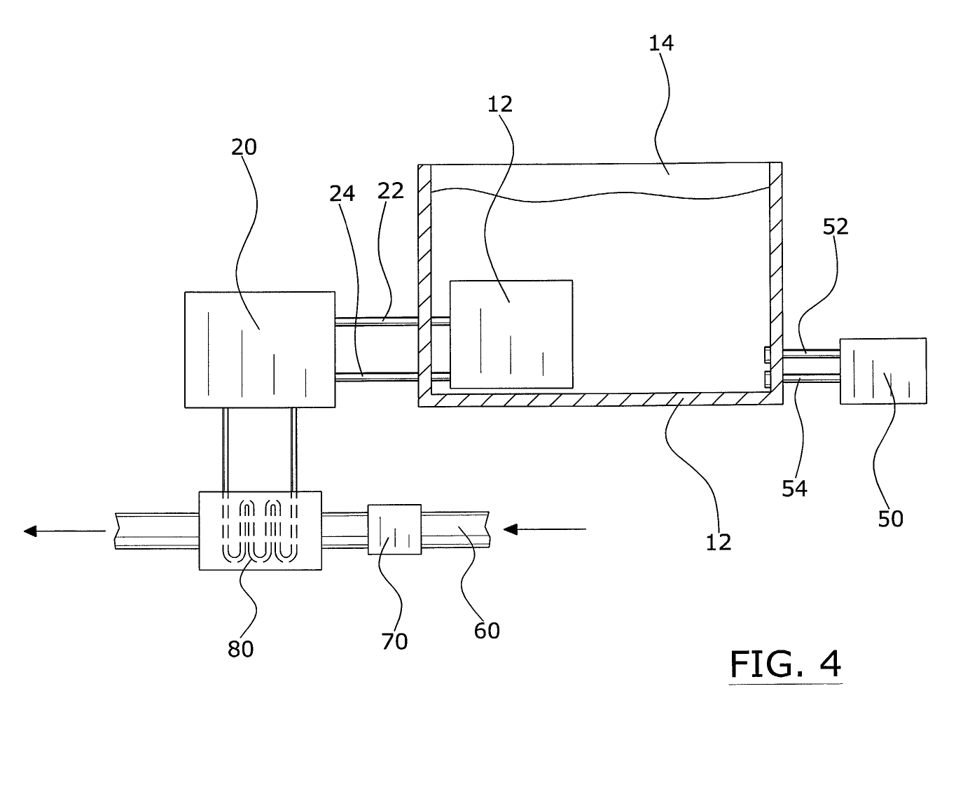

Turning now descriptively to the drawings, in which similar reference characters denote similar elements throughout the several views, FIGS. 1 through 5 illustrate a live well cooling and aeration system 10, which comprises a cold plate 30 positionable within an interior portion 14 of a live well 12 of a boat 16, a compressor 20 in fluid communication with the cold plate 30, a condensing coil 80 in fluid communication with the compressor 20, and an aeration unit 50 in fluid communication with the interior portion 14 of the live well 12. A thermostat within the live well 12 determines when the compressor 20 circulates coolant through the cold plate 30 when the temperature of the water within the live well 12 exceeds a maximum level. When the temperature of the water within the live well 12 is lowered to a minimum level, the thermostat terminates operation of the compressor 20. The aeration unit 50 draws water from within the live well 12, aerates the water and then returns the aerated water back into the live well 12.

As shown in FIGS. 1, 2, 3, 4 and 5 of the drawings, a conventional live well 12 has an interior portion 14 defining a reservoir for receiving a volume of water and fish. The live well 12 may have various shapes, designs and structures as are well established in the art. In addition, the live well 12 may be positioned within various positions and locations throughout the boat 16.

As shown in FIGS. 1 through 5 of the drawings, the cold plate 30 may be comprised of various designs, shapes and structures. The cold plate 30 is preferably removably positionable within the live well 12, however it can be appreciated that the cold plate 30 may be permanently installed within the live well 12 such as within the walls or floor of the live well 12. The cold plate 30 is comprised of a conventional structure having a plurality of channels or tubes running through thereof for transferring heat from the water within the live well 12 to the coolant within the compressor 20 and cold plate 30. The coolant may be comprised of various fluids that are conventional within the heat exchange industry. The cold plate 30 may be formed to be positioned along a sidewall or floor of the interior portion 14 of the live well 12.

As shown in FIGS. 1 through 5 of the drawings, the compressor 20 is in fluid communication with the cold plate 30 via a first line 22 and a second line 24. The compressor 20 is preferably electrically connected to a power source upon the boat 16, however a portable power source may be utilized specifically for the compressor 20 such as a battery or the like. The compressor 20 manipulates the coolant to perform an efficient heat exchange between the cold plate 30 and the condensing coil 80. Heat collected from the cold plate 30 is dispersed through the condensing coil 80 thereby lowering the temperature of the water within the live well 12. The compressor 20 also in fluid communication with the condensing coil 80 for circulating the coolant received from the cold plate 30.

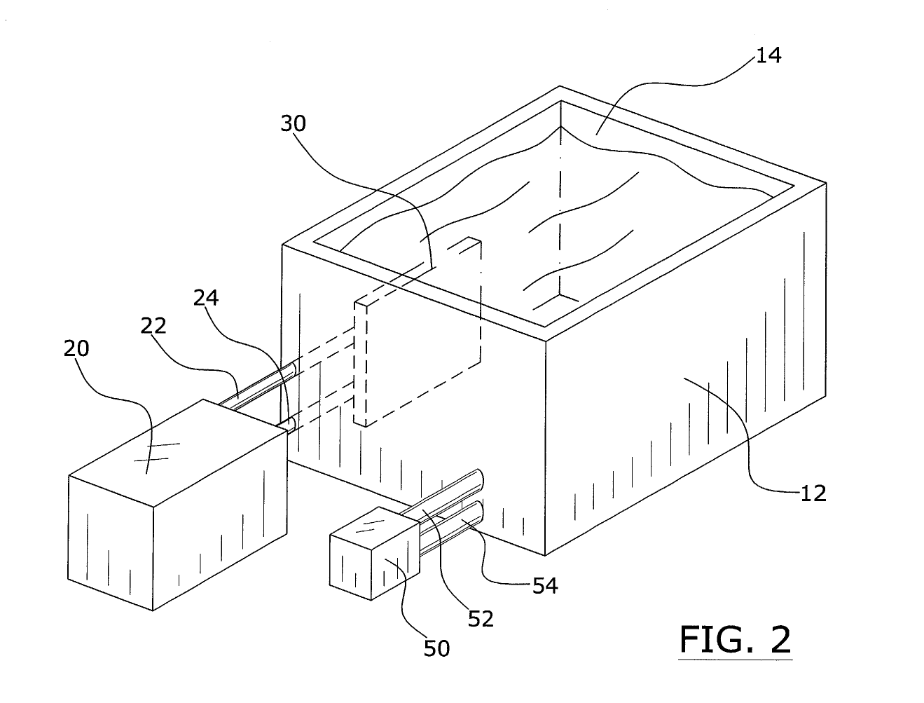

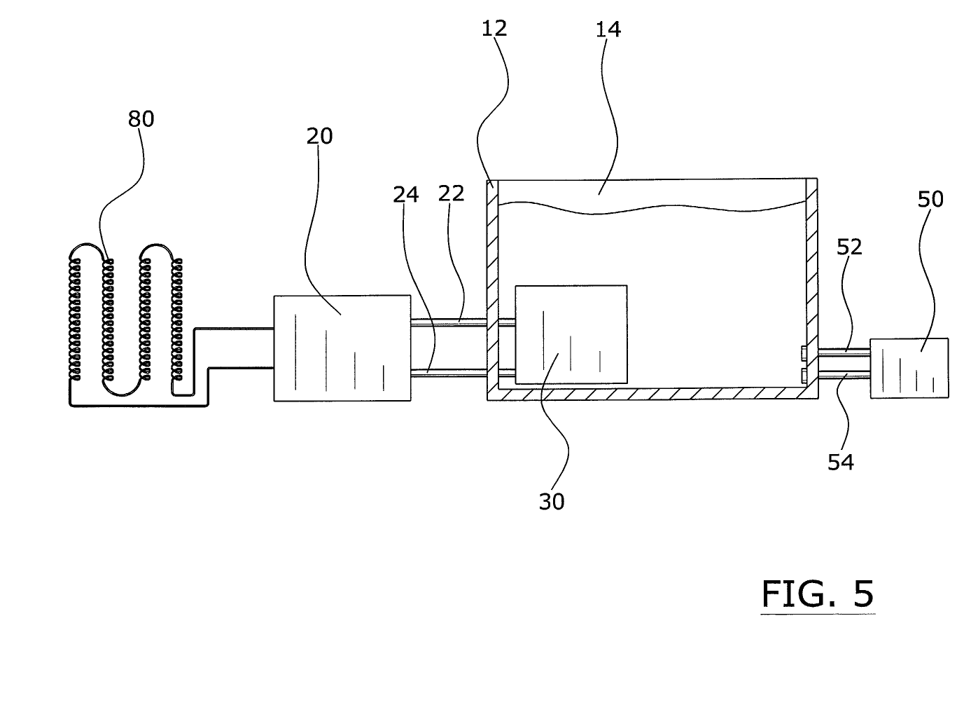

The condensing coil 80 may be positioned within the unit of the compressor 20 as shown in FIG. 2 of the drawings. The condensing coil 80 may also be formed to the shape of the boat 16 and positioned in any location within the boat 16 away from the compressor 20 as illustrated in FIGS. 1 and 5 of the drawings.

In an alternative embodiment, an inlet pipe 60 is positioned within the water surrounding the boat 16 for drawing water over the condensing coil 80 to increase the overall efficiency of cooling the water within the live well 12. The condensing coil 80 is preferably surrounding by a sealed container that is fluidly connected to the inlet pipe 60 and which a pump 70 forces the water through the sealed container thereby drawing the heat from the condensing coil 80 into the water. The heated water is then dispersed back into the water surrounding the boat 16.

A thermostat positioned within the live well 12 determines the approximate temperature of the water within the live well 12. The thermostat is in communication with the compressor 20 for controlling the overall operation of the compressor 20. When the temperature of the water within the live well 12 is raised to a maximum level, the thermostat activates operation of the compressor 20. When the temperature of the water within the live well 12 is lowered to a minimum level, the thermostat terminates operation of the compressor 20. The desired temperature zone may be adjusted utilizing conventional temperature adjustment devices.

The aeration unit 50 draws water from within the live well 12, aerates the water and then returns the aerated water back into the live well 12. The aeration unit 50 is basically comprised of a water propulsion system that incorporates air into the flow of water there through thereby simultaneously aerating and moving the water within the live well 12 which encourages the extended life of the fish within the live well 12. The aeration unit 50 is fluidly connected to the live well 12 through a first aeration line 52 and a second aeration line 54 that are fluidly connected within the live well 12 in various locations to promote water movement within the live well 12.

In an alternative embodiment utilized to operate within multiple live wells 12, a solenoid valve 26 is fluidly connected within the first line 22 connected between the compressor 20 and each of the cold plates 30. When the temperature within one of the live wells 12 is lowered to a minimum level, the appropriate valve 26 is operated to terminate coolant flow through the cold plate 30 until the temperature within the live well 12 is raised to a maximum level. When all of the valves 26 are closed, the compressor 20 is also terminated to avoid damage to the equipment.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A live well cooling and aeration system, comprising:
a cold plate removably positionable within an interior portion of a live well of a boat, wherein said cold plate is in contact with water within said live well; and
a cooling unit fluidly connected to said cold plate for transferring heat from said water within said live well thereby lowering the temperature of said water within said live well.

2. The live well cooling and aeration system of claim 1, including a thermostat positioned within said live well and in communication with said cooling unit, wherein said thermostat terminates said cooling unit when the temperature of said water is lowered to a minimum level and wherein said thermostat activates said cooling unit when the temperature of said water is raised to a maximum level.

3. The live well cooling and aeration system of claim 2, wherein said cooling plate is formed to fit within said interior portion of said live well.

4. The live well cooling and aeration system of claim 3, including an aeration unit in fluid communication with said live well for circulating said water within said live well and aerating said water as said water passes through said aeration unit.

5. The live well cooling and aeration system of claim 4, wherein said aeration unit is fluidly connected to said live well by a first aeration line and a second aeration line.

6. The live well cooling and aeration system of claim 5, wherein said cooling unit is fluidly connected to said cooling plate by a first line and a second line.

7. The live well cooling and aeration system of claim 6, wherein said cooling unit is comprised of a compressor fluidly connected to a condensing coil.

8. The live well cooling and aeration system of claim 7, wherein said condensing coil is positioned a finite distance away from said compressor within a location upon said boat.

9. The live well cooling and aeration system of claim 8, including an inlet pipe fluidly connected to a body of water surrounding said boat, a pump fluidly connected to said inlet pipe for drawing water from said body of water, and a sealed container surrounding said condensing coil fluidly connected to said inlet pipe for receiving said drawn water.

10. The live well cooling and aeration system of claim 1, wherein said cold plate is permanently positioned within said live well.

11. A live well cooling and aeration system, comprising:
a plurality of cold plates removably positionable within an interior portion of a corresponding plurality of live wells within a boat, wherein said plurality of cold plates are in contact with water within each of said plurality of live wells;
a cooling unit fluidly connected to each of said plurality of cold plates by a first line and a second line for transferring heat from said water within each of said plurality of live wells thereby lowering the temperature of said water within said live well; and
a valve positioned within each of said first line for terminating coolant flow through a respective cold plate when a water temperature within a respective live well has lowered to a minimum level thereby allowing coolant to flow through the remaining of said cold plates.

12. The live well cooling and aeration system of claim 11, including a thermostat positioned within each of said plurality of live wells and in communication with said cooling unit, wherein said thermostat terminates said cooling unit when the temperature of said water in all of said plurality of live wells is lowered to a minimum level and wherein said thermostat activates said cooling unit when the temperature of said water in any of said plurality of live wells is raised to a maximum level.

13. The live well cooling and aeration system of claim 12, wherein said cooling plate is formed to fit within said interior portion of said live well.

14. The live well cooling and aeration system of claim 13, including an aeration unit in fluid communication with each of said plurality of live wells for circulating said water within said live wells and aerating said water as said water passes through said aeration unit.

15. The live well cooling and aeration system of claim 14, wherein said aeration unit is fluidly connected to said live well by a first aeration line and a second aeration line.

16. The live well cooling and aeration system of claim 15, wherein said cooling unit is comprised of a compressor fluidly connected to a condensing coil.

17. The live well cooling and aeration system of claim 16, wherein said condensing coil is positioned a finite distance away from said compressor within a location upon said boat.

18. The live well cooling and aeration system of claim 17, including an inlet pipe fluidly connected to a body of water surrounding said boat, a pump fluidly connected to said inlet pipe for drawing water from said body of water, and a sealed container surrounding said condensing coil fluidly connected to said inlet pipe for receiving said drawn water.

19. The live well cooling and aeration system of claim 11, wherein said cold plate is permanently positioned within each of said plurality of live wells.
